(19) United States
(12) Patent Application Publication
(10) Pub. No.: US 2016/0375522 A1
(43) Pub. Date: Dec. 29, 2016

(54) WELDING METHOD FOR SUPERALLOYS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/751,279

(22) Filed: Jun. 26, 2015

(51) Int. Cl. B23K 26/34; B23K 26/32

(52) U.S. Cl. CPC B23K 26/34; B23K 26/32

(57) ABSTRACT

A method of welding with low shrinkage stress, including forming an excavation (42, 70) in a surface (24, 76) of a substrate (24, 76) with a shallow geometry (D, W, A) limited to surfaces oriented within 45 degrees of the surface. Molten weld metal (46, 80) in the excavation solidifies with largely unopposed shrinkage vectors directed toward the substrate within 45 degrees of normal to the surface. The molten metal may be warmed along the sides of the excavation (42A, 42B) so it solidifies upward (56) from the bottom, rather than from the sides inward. A metal insert (78, 84) may be fitted into the excavation and welded along the interface between them using a process that minimizes mechanical restraint on the weld by accommodating weld shrinkage.

### FIELD OF THE INVENTION

This invention relates to welding methods, and particularly to welding repairs of service-induced defects in superalloy components such as gas turbine blades.

### BACKGROUND OF THE INVENTION

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair, and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

The present inventors have developed a superalloy welding technique using powdered flux and metal as disclosed in United States Patent Application Publication US 2013/0140278 A1, incorporated by reference herein. That process, identified with the service mark and trademark “SieFlux”, facilitates the deposition of even the most difficult to weld superalloys. However, further improvements are desired for the weld repair of superalloy material components.

### BRIEF DESCRIPTION OF THE DRAWINGS

The invention is explained in the following description in view of the drawings that show:

FIG. 1 is a sectional view of a conventional defect excavation and repair weld.

FIG. 2 is a sectional view of an excavation weld illustrating aspects of an embodiment of the invention.

FIG. 3 illustrates melting and post-melt weld warming in a further embodiment.

FIG. 4 is a top view of an excavation weld in a further embodiment.

FIG. 5 is a side view of a cracked wall with repair excavation geometry.

FIG. 6 shows an insert fitted and welded into the excavation geometry of FIG. 5.

FIG. 7 shows a repair insert with a larger radius of curvature than the excavation

FIG. 8 shows progressive gap closure in the embodiment of FIG. 7 caused by, and accommodating, weld shrinkage.

FIG. 9 shows a repair insert positioned to create a widthwise tapered gap.

FIG. 10 shows progressive gap closure in the embodiment of FIG. 9 caused by, and accommodating, weld shrinkage.

### DETAILED DESCRIPTION OF THE INVENTION

The inventors recognized that welding repairs of defects in superalloy components can fail because the excavation geometry fails to accommodate shrinkage of the melt pool. Areas of the melt that are last to solidify have grain boundaries still wet from low melting point eutectic compositions. These boundaries are pulled apart by opposed shrinkage of the deposit laterally from the sides of the excavation. Even when cracking is not produced, residual stresses remain after welding. Such stresses add to stresses resulting from post-process heat treatment, producing what is commonly referred to as strain age cracking or reheat cracking.

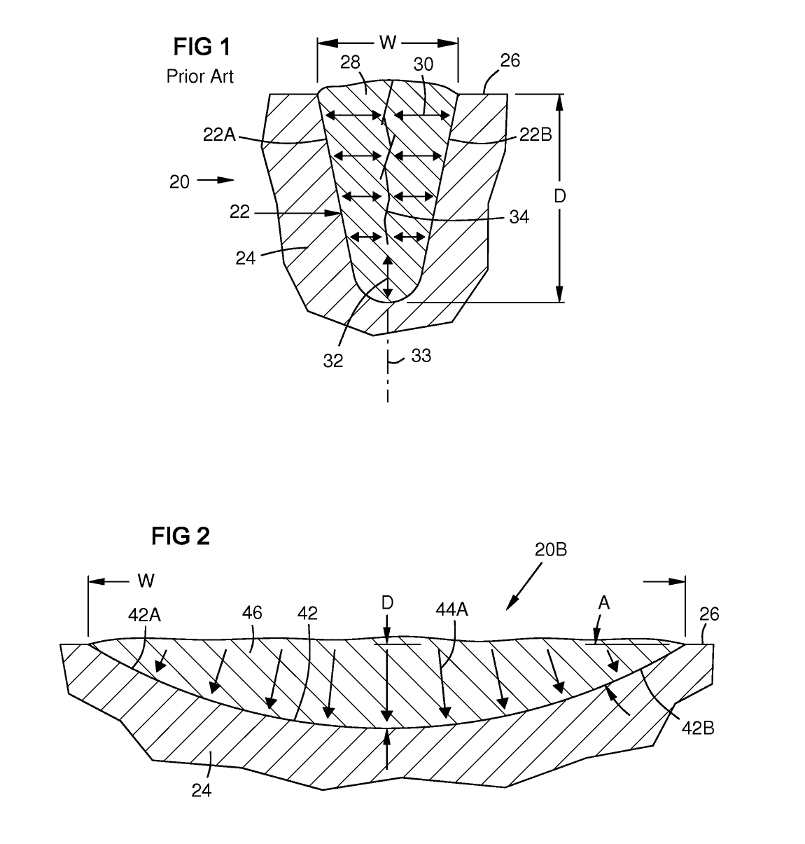

FIG. 1 illustrates a conventional component repair weld 20 having a weld excavation 22 with relatively steep sides 22A, 22B. Such weld is typically used to repair a crack or other defect in a substrate 24 by removing material from a surface 26 of the substrate to a depth necessary to remove the defect (not shown). Weld metal 28 is then added in one or more passes to fill the excavation 22. This may be done by laser melt deposition of powdered superalloy material or another known process. The depth D of the excavation may be greater than its width W to minimize material removal. As heat is lost from the melt pool into the substrate 24, the deposit solidifies and shrinks laterally 30 and vertically 32 starting from the cavity walls. The last area to solidify is along the lateral mid-plane 33 of such a weld. Material in this area can separate from the shrinkage stress, forming a crack 34 or a plane of weakness.

FIG. 2 shows a weld 20B illustrating aspects of an embodiment of the invention. The weld excavation 42 is relatively shallow, for example having a depth D not greater than 25% of its width W and having sides 42A, 42B meeting the substrate surface 26 at an angle A not exceeding 45 degrees. All surfaces of the excavation may be oriented within 45 degrees of a plane of the surface 26. “Within” in this context means not exceeding. In one embodiment, the excavation may be formed as a circular arc not exceeding 90 degrees as seen in cross section. All tangents to such arc are within 45 degrees of the local plane of the substrate surface 26. Weld metal forms a melt pool 46, which may be created by melting a filler material such as a powdered material as later shown. The geometry of the excavation causes all shrinkage 44A of the melt pool 46 to be directed toward the substrate and within 45 degrees of normal to the substrate 24. Shrinkage occurs upward from the bottom of the excavation, and is substantially unopposed because the top of the melt pool subsides to accommodate it. Therefore little or no tensile stress (and minimal relative to the prior art) remains. Such shallow excavation requires removal of much more substrate material to achieve sufficient depth D than does the prior geometry of FIG. 1, making the shallow geometry non-obvious. However, the beneficial tradeoff is a successful weld with minimized residual stress.

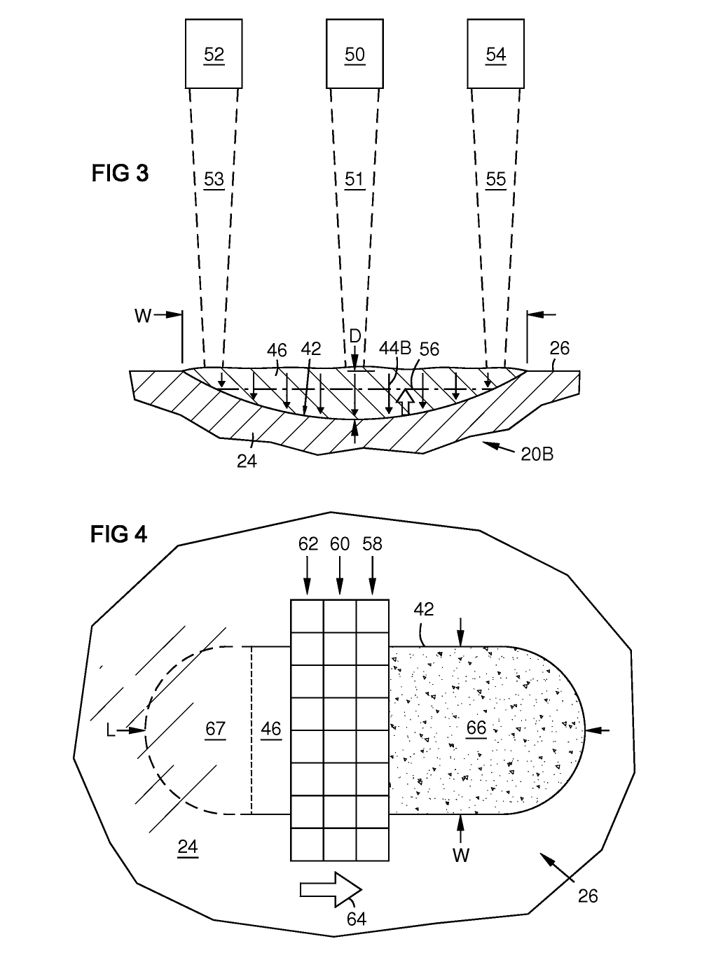

FIG. 3 illustrates a method for further controlling the shrinkage vectors 44B. A first laser device 50 may control a first energy 51 to form the melt pool 46 by directing the energy to traverse a filler material laterally, and to progress it along the length of the filler material. The length dimension is normal to the plane of this figure. One or more further laser devices 52, 54 may follow the first laser device 50 in the lengthwise dimension to direct further energy 53, 55 that keeps the sides of the deposit warm so that it solidifies from the bottom up, rather than from the sides laterally inward. Alternatively, a single laser may be controlled to provide the desired temperature profile. A gradient profile of warming energy may be applied across the width W of the deposit by the following lasers 52, 54, such that the solidification front 56 progresses upward and is substantially planar and parallel to the surface 26. This orients all shrinkage vectors 44B substantially unidirectionally normal to the surface 26 of the substrate, eliminating lateral tension vector components in the resulting weld.

FIG. 4 shows a top view of an excavation 42 that may be formed by a ball end mill to remove a defect that does not penetrate the thickness of the substrate. A row of melting lasers 58 is followed in this example by two rows of warming lasers 60, 62, all of which traverse 64 the length L of the excavation 42 after it is filled with filler material 66 to create a melt pool 46 that solidifies into a weld deposit 67. The melting lasers 58 may provide a gradient profile of energy across the width W of the excavation proportional to the excavation depth at each laser element. The warming lasers 60, 62 may provide a three dimensional warming gradient with dimensions of power per excavation width location per time after melt that causes solidification to proceed along a substantially planar solidification front 56 (FIG. 3) that is substantially parallel to the surface 26 of the substrate 24. The warming lasers may additionally provide warming of the component surface 26 beside the excavation 42 to reduce lateral chill effects on the sides of the melt pool 46 by the substrate. One skilled in the art will recognize that the desired temperature profile may alternatively be obtained with fewer lasers or with only a single laser which is controlled to provide the desired power gradient across the surface.

FIG. 5 shows an excavation 70 to be formed in a wall 72 of a component in order to remove a defect 74 that penetrates the wall and starts from an edge 76 thereof. The excavation 70 is relatively shallow as previously described, for example having a depth D not greater than 25% of its width W and having all excavation surfaces oriented within 45 degrees of a plane of the edge 76. In one embodiment, the excavation may be formed as a circular arc not exceeding 90 degrees extent as seen in cross section. With such excavation, all planes tangent to the excavation surface are oriented within 45 degrees of the plane of the edge 76.

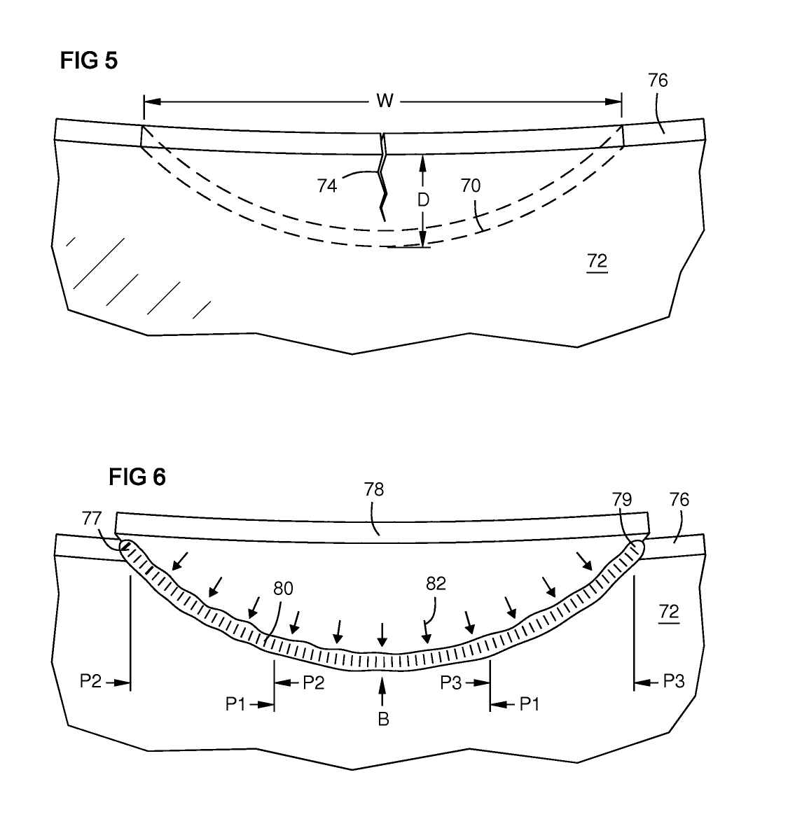

FIG. 6 shows a repair insert 78 inserted into the excavation 70 and welded 80 along the interface between them. The weld may be autogenous or filled with a consumable filler after excavating along the interface. The insert matches and fits into the excavation 70, and has no aspect that limits its motion into the excavation except its contact with the walls of the excavation. This geometry causes all shrinkage 82 to be directed toward the substrate within 45 degrees of normal to the plane of the edge 76. In one embodiment the wall 72 may be a side wall of a turbine blade airfoil, and the edge 76 may be the truncated top edge of the blade wall after removing the blade cap. Alternately, the weld may be started in a run-on area 77 at one side of insert 78, progress along the interface between the insert and the excavation, and end in a run-off area 79 at the opposite side of the insert.

Shrinkage stress in FIG. 6 can be minimized if welding starts at the bottom center B of the excavation and progresses simultaneously in both directions from there. As a bottom central portion P1 such as the central ⅓ of the weld solidifies and shrinks, the outer portions P2, P3 are liquid, allowing the insert 78 to settle into the shrinkage along the span of P1. The bottom center portion P1 of the weld may be allowed to solidify just enough to support the weight of the insert before the outer portions P3 are finished. For maximum effectiveness of this technique, through-wall melting may be performed in the welding step. Where the geometry of the part 72 permits, welding may be performed on both sides of the wall 72 simultaneously with laser beams directed by galvanometer driven mirrors, providing a rapid through-wall melt. The shape and location of the insert 78 may differ from the excavation 70 just enough such that shrinkage progressively brings the upcoming mating surfaces in intimate contact, and minimizes mechanical restraint on the weld.

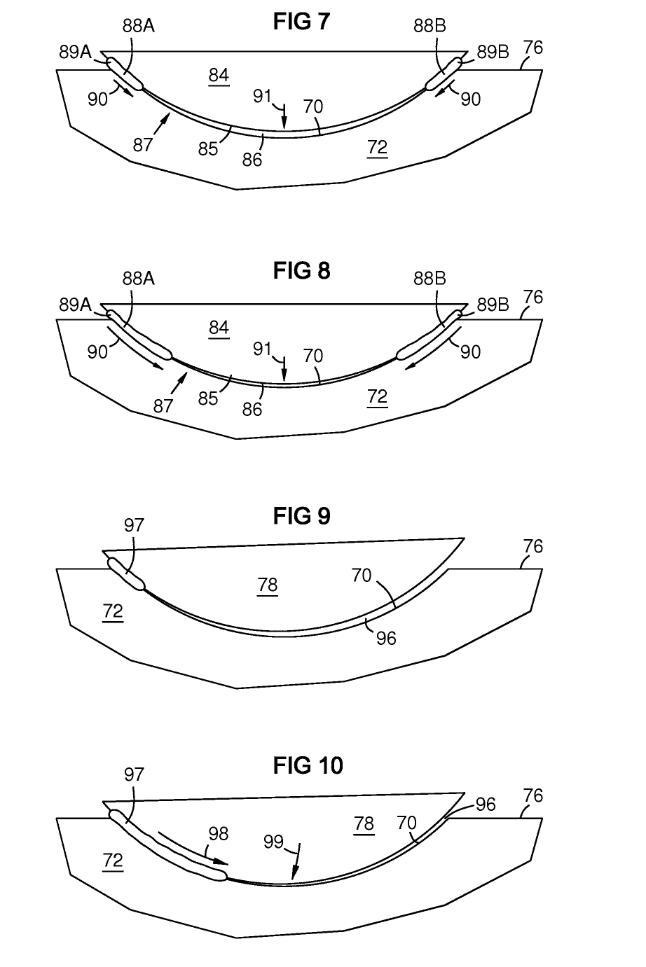

FIG. 7 shows a repair insert 84 having a mate face 85 with a larger radius of curvature than the excavation 70. This creates a tapered gap 86 at bottom center of the insert/excavation interface 87 as the insert bridges the width of the excavation. Two welds 88A, 88B may be started simultaneously with run-ons 89A, 89B on opposite sides of the mate face 85, and progress 90 toward the middle of the interface. The starting locations 89A, 89B may be on the insert 84 above the wall edge 76. The tapered gap 86 gradually closes, accommodating shrinkage and avoiding restraint until the weld is finished near the maximum depth of the excavation. This geometry and process allows the insert 84 to settle 90 to accommodate weld shrinkage as the weld progresses as shown in FIG. 8. Tapering of power at the stop location may be used to avoid weld end cratering.

FIG. 9 shows a repair insert 78 positioned relative to an excavation 70 to create a widthwise tapered gap 96 between them. A weld 97 starts at the small end of the tapered gap 96. FIG. 10 shows the weld 97 progressing 98 along the gap, which progressively closes 99 due to weld shrinkage as the weld progresses, accommodating the weld shrinkage. The tip of a gas turbine blade for land based operation is commonly 100 to 300 mm in chord length by 5 to 40 mm in width. Cracks extending from such tip may be up to 20 mm in length, and are typically aligned with the blade span or stacking axis. A 20 mm deep excavation with a 90-degree circular arc cross section has side surfaces that meet the top edge (26 in FIG. 2-4; or 76 in FIGS. 5-6) at 45 degrees and has an excavation width W of less than 100 mm. This fits within 100 to 300 mm long blade tips.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of welding comprising:
forming an excavation in a surface of a metal component;
introducing molten metal into the excavation; and
allowing the molten metal to cool and solidify;
wherein the excavation comprises a geometry that causes the molten metal to solidify with all shrinkage therein directed inward relative to the component and within 45 degrees of normal to the surface of the component.

2. The method of claim 1, wherein the excavation further comprises first and second sides that each meet the surface of the component within 45 degrees of a plane of the surface of the component.

3. The method of claim 2, further comprising:
disposing a filler material in the excavation;
traversing the filler material with a first laser energy to create the molten metal;
following the first energy with a second energy that warms the molten metal along the first and second sides of the excavation proximate the surface of the component so that the molten metal solidifies upward from a bottom of the excavation, rather than from the sides laterally inward.

4. The method of claim 3, further comprising providing a warming profile via the second energy that shapes an upward moving solidification front in the molten metal that is substantially parallel to the plane of the surface of the component.

5. The method of claim 1, wherein all surfaces of the excavation have a surface angle within 45 degrees of an angle of a plane of the surface of the component adjacent the excavation.

6. The method of claim 1, wherein the geometry of the excavation comprises a width of the excavation being at least 4 times a depth thereof.

7. The method of claim 1, wherein the geometry of the excavation is a circular arc not exceeding 90 degrees in a sectional view thereof.

8. The method of claim 1, further comprising:
fitting a metal insert into the excavation, thus forming an interface there between; and
wherein the step of introducing molten metal comprises welding the interface starting at a central portion thereof and progressing simultaneously laterally to first and second ends thereof, forming a weld line.

9. The method of claim 8, wherein the component is a gas turbine engine airfoil, said surface of the component is a top edge of a side wall of the airfoil, wherein the weld line is formed by melting through the side wall along the interface; and further comprising allowing a central portion of the weld line to solidify enough to support a weight of the insert before completing the weld line to the ends thereof.

10. The method of claim 1 further comprising:
positioning a metal insert relative to the excavation to provide a tapered gap there between, and
introducing the molten metal in a direction along the tapered gap, wherein shrinkage during the solidification therein progressively brings upcoming portions of the tapered gap to close.

11. A method of welding, comprising:
creating an excavation in a surface of a superalloy metal component, the excavation having a depth not greater than 25% of its width;
at least partially filling the excavation with a metal comprising a molten metal; and
allowing the molten metal to solidify with substantially unopposed shrinkage normal to the surface of the component.

12. The method of claim 11, further comprising:
placing a metal filler material in the excavation and melting it with laser energy to form the molten metal; and
warming the molten metal with a further energy along opposed sides of the excavation proximate the surface of the component, causing the molten metal to solidify upward from the bottom of the excavation rather than from the sides laterally inward.

13. The method of claim 12, further comprising providing a warming profile to the molten metal via the further energy that creates a solidification front in the molted metal that is substantially parallel to the surface of the component.

14. A method of welding, comprising:
creating an excavation in a surface of a metal component;
at least partially filling the excavation with a metal comprising a molten metal; and
causing the molten metal to solidify with substantially unopposed shrinkage directed to within 45 degrees of normal to the surface of the component.

15. The method of claim 14, wherein said surface of the component is a surface of an edge of a wall of the component, and further comprising:
fitting a metal insert into the excavation, forming an interface between the metal insert and the excavation, the interface comprising a central portion and two ends; and
melting progressively through the wall and the insert along the interface starting from a central portion of the interface and progressing laterally simultaneously to first and second ends thereof to form a weld line between the metal insert and the excavation.

16. The method of claim 14, further comprising:
placing a metal filler material in the excavation, and melting it with a laser energy to form the molten metal;
warming the molten metal with a further energy along opposed sides of the excavation proximate the surface of the component, causing the molten metal to solidify upward from the bottom of the excavation, rather than from the sides laterally inward.

17. The method of claim 16, further comprising providing a warming profile to the molten metal via the further energy that creates a solidification front in the molten metal that is substantially parallel to the surface of the component.

18. The method of claim 14, further comprising:
shaping and positioning a metal insert relative to the excavation to provide a tapered gap there between, and
welding from one or more positions along said gap wherein, and as the welding progresses, shrinkage therein progressively brings upcoming portions of the insert and the excavation into contact.

19. The method of claim 14, further comprising:
bridging the excavation widthwise with a metal insert comprising a mate face with a larger radius of curvature than a widthwise curvature of the excavation, forming a tapered gap along an interface there between, the tapered gap being greatest at a bottom center of the interface; and
starting first and second welds simultaneously at first and second sides of the excavation, and progressing the welds toward the bottom center of the interface, progressively closing the tapered gap by weld shrinkage as the welds progress.

20. The method of claim 14, further comprising:
partly inserting a metal insert into the excavation in a position that creates a widthwise tapered gap along an interface there between; and
starting a weld at a minimal end of the tapered gap and progressing the weld along the interface, progressively closing the tapered gap by weld shrinkage as the weld progresses.
